(19) United States
(12) Patent Application Publication
(10) Pub. No.: US 2009/0059946 A1
(43) Pub. Date: Mar. 5, 2009

(54) Method for Selective Backward Routing in a Workflow System

(76) Inventors: Yoshihito Iba, Tokyo (JP); Ryohichi Yoshimura, Sagamihara-shi (JP)

Correspondence Address: RYAN, MASON & LEWIS, LLP, 1300 POST ROAD, SUITE 205, FAIRFIELD, CT, 06824, US

(21) Appl. No.: 11/849,656

(22) Filed: Sep. 4, 2007

(51) Int. Cl. H04L 12/54

(52) U.S. Cl. 370/429

(57) ABSTRACT

Techniques for selective backward routing in a workflow system are provided. For example, one technique includes obtaining workflow processing history information, obtaining one or more conditions for selection of the one or more valid return destinations, wherein the one or more conditions are defined in advance, and combining the workflow processing history information and the one or more conditions to determine the one or more valid return destinations in the workflow. Techniques are also provided for executing a valid return action in a workflow.

### FIELD OF THE INVENTION

The present invention relates to information technology and, more particularly, to routing in a workflow system.

### BACKGROUND OF THE INVENTION

In a workflow system, actions such as “sending,” “approval,” “denial” and “sending-back” are defined as actions that may be taken by processing persons during processing person activities. Sending-back, or returning, refers to an action taken by an approving person to return a form or a task to a former processing person who may be a processing person in the preceding stage, a processing person in the second-prior or any other preceding stage (that is, a multi-stage sending-back) or a form originator.

As used herein, there is a difference between “sending-back” and “approval and/or denial (rejections).” While approval and denial (rejections) are decisions made final by a certain processing person in a business process, sending-back, or returning, is not a final decision but an operation to provide an opportunity to redo or correct the form input operation. For example, in a case where a slight error exists in an input field of a form, the form is sent back to a former processing person to give the processing person a chance to redo or correct the input. At the time of sending-back, a reason for sending-back is ordinarily attached. The former processing person redoes or corrects the input by referring to the sending-back reason.

With sending-back, there is a problem as to how a sending-back or return destination processing person is determined. Existing approaches include a method in which a sending-back path is defined at the time of process design. However, with respect to this approach, there is a problem in that when a multiplicity of processing person activities exist on a workflow path, sending-back paths will be increasingly complicated.

Existing approaches also include a method in which a sending-back destination is determined on the basis of a processing history. Sending back to the former processing person or the second former or any other preceding processing may be completed without defining any sending-back path. Also, with respect to this approach, return to a processing person in any of the second and/or other preceding stages may be done by referring to a processing history. A sending-back destination is determined by a processing person making a selection from a list in a processing history. However, regarding this approach, there is a problem wherein a list in a processing history contains a processing person negligible as a sending-back destination or a processing person who is undesirable as a sending-back destination.

Also, existing approaches include a method in which a processing person designates an arbitrary sending-back destination. This approach is often seen, for example, in workflow systems by electronic mail. The approach includes flexibility such that a sending-back destination can be freely set, but entails a risk of sending back to a processing person not in accordance with a proper intention.

Existing approaches additionally include a method in which a form is sent back by identifying a field where an input imperfection exists. This approach automatically determines a sending-back destination by identifying a field. The approach requires maintaining an editor history on a field-by-field basis but encounters a problem when the number of fields per form becomes enormously large. In such a case, the history storage area becomes increasingly enlarged.

Also, existing approaches include a method in which a sending-back condition is designated to dispatch forms that are to be sent back and those forms that are not to be sent back. This approach includes a processing person designating a sending-back condition to determine a sending-back destination. However, requiring a processing person to designate a sending-back condition increases the load on the processing person and entails a risk of input of an unauthorized condition.

### SUMMARY OF THE INVENTION

Principles of the present invention provide techniques for selective backward routing in a workflow system.

For example, in one aspect of the invention, a technique for determining one or more valid return destinations in a workflow includes the following steps. Workflow processing history information is obtained. One or more conditions for selection of the one or more valid return destinations are obtained, wherein the one or more conditions are defined in advance. The workflow processing history information and the one or more conditions are combined to determine the one or more valid return destinations in the workflow.

In another aspect of the invention, a technique for executing a valid return action in a workflow includes the following steps. A request is obtained from a requesting workflow user to return a task to a previous workflow user. One or more conditions are collected for selection of one or more valid return destinations for all previously completed workflow user activities. The one or more conditions are evaluated to determine which of the one or more conditions correspond to one or more valid return destinations. The one or more valid return destinations are displayed to the requesting workflow user. A valid return action is executed, wherein the requesting workflow user selects one of the one or more valid return destinations.

At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating evaluation of conditions for selective backward routing, according to an embodiment of the present invention;

FIG. 2A is a diagram illustrating selective backward routing, according to an embodiment of the present invention;

FIG. 2B is a diagram illustrating selective backward routing, according to an embodiment of the present invention;

FIG. 2C is a diagram illustrating selective backward routing, according to an embodiment of the present invention;

FIG. 2D is a diagram illustrating selective backward routing, according to an embodiment of the present invention;

FIG. 3 is a diagram illustrating selective backward routing, according to an embodiment of the present invention;

FIG. 4 is a diagram illustrating selective backward routing, according to an embodiment of the present invention;

FIG. 5 is a system diagram of an exemplary computer system on which at least one embodiment of the present invention can be implemented;

FIG. 6 is a diagram illustrating selective backward routing, according to an embodiment of the present invention;

FIG. 7 is a flow diagram illustrating techniques for determining one or more valid return destinations in a workflow, according to an embodiment of the present invention;

FIG. 8 is a flow diagram illustrating techniques for executing a valid return action in a workflow, according to an embodiment of the present invention.

FIG. 9 is a diagram illustrating selective backward routing, according to an embodiment of the present invention;

FIG. 10 is a diagram illustrating selective backward routing, according to an embodiment of the present invention;

FIG. 11 is a diagram illustrating an exemplary system configuration for selective backward routing, according to an embodiment of the present invention;

FIG. 12 is a diagram illustrating an exemplary data structure, according to an embodiment of the present invention; and

FIG. 13 is a flow diagram illustrating techniques for selective backward routing, according to an embodiment of the present invention.

### DETAILED DESCRIPTION OF PREFERRED EMBODIMENTS

Principles of the present invention determine a valid sending-back or return destination according to a combination of workflow processing history information and one or more conditions for selecting of a return destination defined in advance during a processing person activity.

Additionally, principles of the present invention enable the dynamic determination of effective candidate destinations for backward routing (that is, return destinations) depending on the current status of a workflow process instance. By way of example, candidate destinations for backward routing vary depending on which activity is the current activity. If the current activity is positioned to the activity in question after appropriate approvals have been completed, then the backward routing to the staff prior to the approval activities should be forbidden. Take, for example, a workflow such as one including: Issuer→Approver A→Approver B→Administrator A→Administrator B (current activity)→End. In this exemplary workflow, backward routing to either Approver A or Approver B should be foreclosed because both individuals have made a decision/approval as to their position. However, backward routing to Administrator A can be permitted (for example, to correct his or her input).

An activity may include, for example, a staff activity, a program execution activity, a mail-sending notification activity, a database storing activity, etc. Activites may be, for example, human-involved activities and/or machine-processing activities.

Principles of the present invention also provide an opportunity for workflow users to generating a list of one or more valid sending-back destinations. A user may also select the destination for backward routing from the list of destinations being extracted as effective candidates for backward routing. Furthermore, in one or more embodiments of the present invention, it is not necessary to define the backwards paths, and only valid staff, or workflow users, are to be included in the backward destinations. Staff can include, for example, a workflow user, a participant in a given workflow or one who processes a task related to a workflow. For example, by assigning appropriate conditions to the activity during design time, safe operations for backward routing are realized by preventing backward routing to unintended staff.

In a workflow system including, as a constituent element, a workflow engine and a workflow client, the workflow engine evaluates sending-back or return destination selection conditions defined in advance with respect to processing person activities related to individual items of processing history information on a form or in a task. The evaluation is performed by referring to the processing history information items when sending the form to the next processing person, and generating a list of valid sending-back destinations for the next processor.

A condition for selective backward routing is a condition to determine which set of previous staff, or workflow users, can be candidates for backward routing. In a workflow process definition, one or more of these conditions are defined as one or more design properties of a staff activity. These conditions can be described, for example, in a logical formula so that a workflow engine can evaluate them.

On the workflow client, the list of the valid return destinations evaluated by the engine can be displayed to a workflow user on a client screen through a suitable user interface (UI) such as, for example, a dialog list. The user can execute a return action by selecting one of the return destinations in the list.

In one or more embodiments of the present invention, a list of valid return destinations may be dynamically determined in response to situations with a form or task. For example, in a process requiring a plurality of approvals, a condition may be set such that a processing person activity that is already approved is excluded from a valid return destination list. In another example, a condition may be set such that if a processing history contains activities (for example, an activity to execute mechanical processing) other than processing person activities, they are excluded from a valid return destination list. In yet another example, in a hierarchical workflow system, a condition may be set such that a valid sending-back destination list is changed between a situation where a form is in a sub-process and other situations.

In one or more embodiments of the present invention, a return destination list is evaluated on the workflow engine side. This evaluation enables a workflow user to select a suitable processing person in a list of processing persons to which a return can be performed with reliability. The approaches in which a workflow user arbitrarily designates a return destination processing person and in which an arbitrary return condition is designated entail a risk of returning to a processing person that is not in accordance with a proper intention.

In one or more embodiments of the present invention, a workflow designer suitably sets return enabling conditions in advance to eliminate the possibility of returning to a processing person that is not in accordance with the proper intention of a workflow user. As a result, a safe return operation environment is provided.

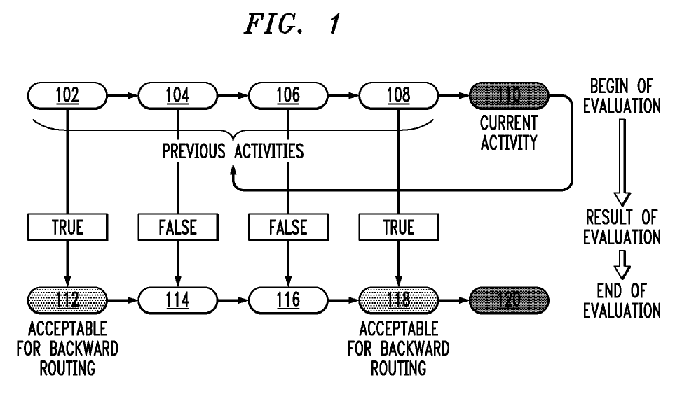

Given the above realizations made in accordance with one or more embodiments of the present invention, and general features associated therewith, the remainder of the detailed description will provide an illustrative explanation of techniques for implementing such realizations and features in the context of FIGS. 1 through 13.

FIG. 1 is a diagram illustrating evaluation of conditions for selective backward routing, according to an embodiment of the present invention. By way of illustration, FIG. 1 depicts previous activities 102 (which corresponds with activity 112), 104 (which corresponds with activity 114), 106 (which corresponds with activity 116) and 108 (which corresponds with activity 118). Also, FIG. 1 depicts a current activity 110 (which corresponds with activity 120).

When a workflow user requests to return a task or form to a previous staff or previous workflow user, the workflow engine will collect and evaluate conditions for selective backward routing for all previous staff activities (for example, 102, 104, 106 and 108) that have already been completed. As a result of the evaluation, a set of activities for which conditions have been evaluated as true (for example, 112 and 118) is deemed a list of valid destinations for backward routing (that is, valid return destinations). As indicated in FIG. 1, for example, “true” denotes that an activity is acceptable for backward routing and “false” denotes that an activity is not acceptable for backward routing.

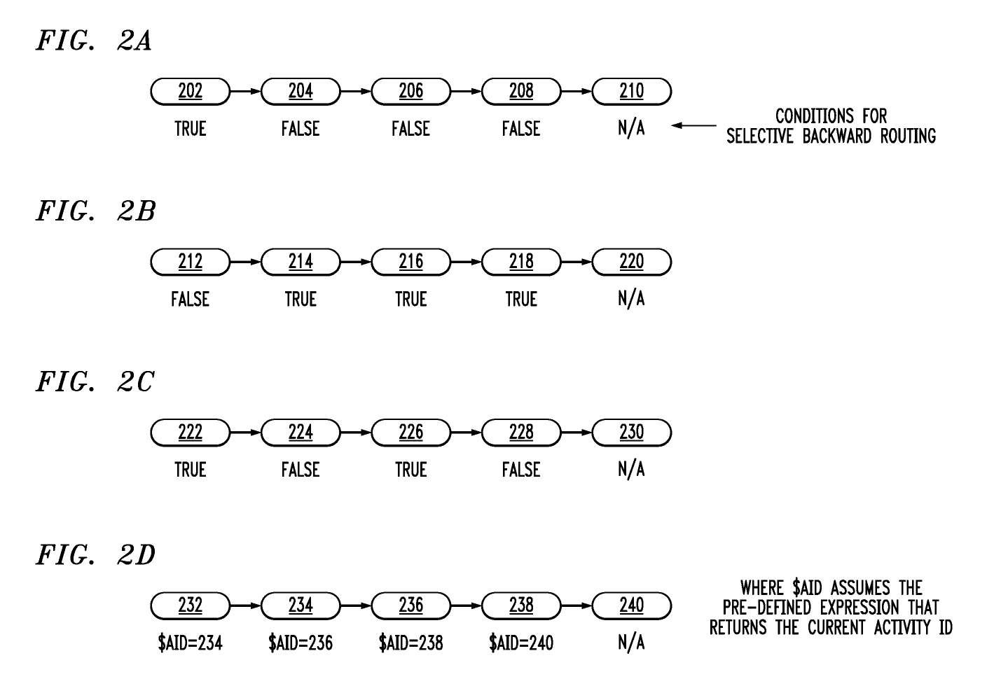

FIG. 2A is a diagram illustrating selective backward routing, according to an embodiment of the present invention. By way of illustration, FIG. 2A depicts conditions to allow backward routing to the submitter only (illustrated herein by activity 202). Activity 210 is the last activity of the workflow process (which also includes activities 204, 206 and 208) and never becomes a candidate for backward routing. So the condition of 210 is n/a, as illustrated in FIG. 2A. The status of “n/a” indicates that an activity is not capable of becoming a candidate for backward routing.

FIG. 2B is a diagram illustrating selective backward routing, according to an embodiment of the present invention. FIG. 2B depicts conditions to allow backward routing to the staff except submitter (illustrated herein by activity 212), and includes activities 214, 216 and 218. FIG. 2B also includes activity 220, which is the last activity of the workflow process.

FIG. 2C is a diagram illustrating selective backward routing, according to an embodiment of the present invention. By way of illustration, FIG. 2C depicts conditions to allow backward routing to the specific staff, herein identified as 222 and 226 in FIG. 2C. FIG. 2C also includes activities 224, 228 and 230.

FIG. 2D is a diagram illustrating selective backward routing, according to an embodiment of the present invention. FIG. 2D depicts conditions to allow backward routing to the staff just before the current activity. FIG. 2D includes activities 232, 234, 236, 238 and 240. “$aid” represents a computational equation that returns one or more activity identifications after evaluation by a workflow engine.

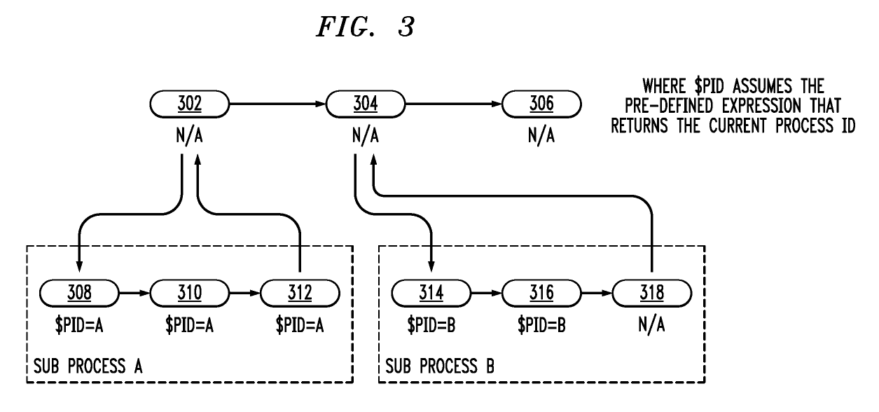

FIG. 3 is a diagram illustrating selective backward routing, according to an embodiment of the present invention. By way of illustration, FIG. 3 depicts conditions to allow backward routing with a target scope restricted to the current sub-process. FIG. 3 includes activities 302 (which corresponds with Sub-Process A, which includes activities 308, 310 and 312), 304 (which corresponds with Sub-Process B, which includes activities 314, 316 and 318) and 306. Workflow processing history information assumes to be stored continuously across sub-processes. If, for example, the current activity is located in Sub Process A, then $pid=A is true because $pid returns to an activity in Sub Process A. If, for example, the current activity is located in Sub Process B, then $pid=A is false.

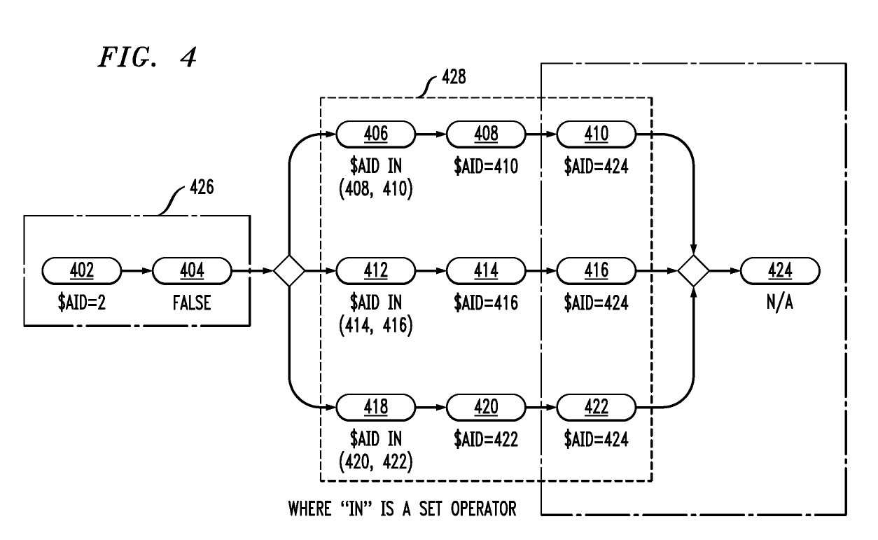

FIG. 4 is a diagram illustrating selective backward routing, according to an embodiment of the present invention. By way of illustration, FIG. 4 depicts conditions to allow backward routing in a workflow process that contains parallel paths. FIG. 4 includes activities 402, 404, 406, 408, 410, 412, 414, 416, 418, 420, 422 and 424, as well as scopes 426 and 428. A scope, as used herein, is a set of one or more activities.

In scope 426, only backward routing from activity 404 to 402 is allowed. In scope 428, backward routing to the multiple staff or workflow users in the same branch path is allowed, while backward routing to activities 402 and 404 is not allowed. For activity 424, only backward routing to activity 410, 416 or 422 is allowed.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

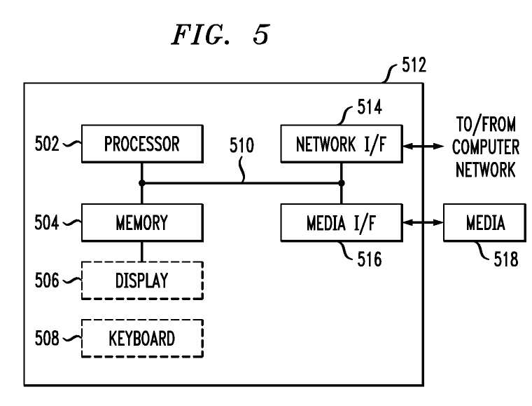

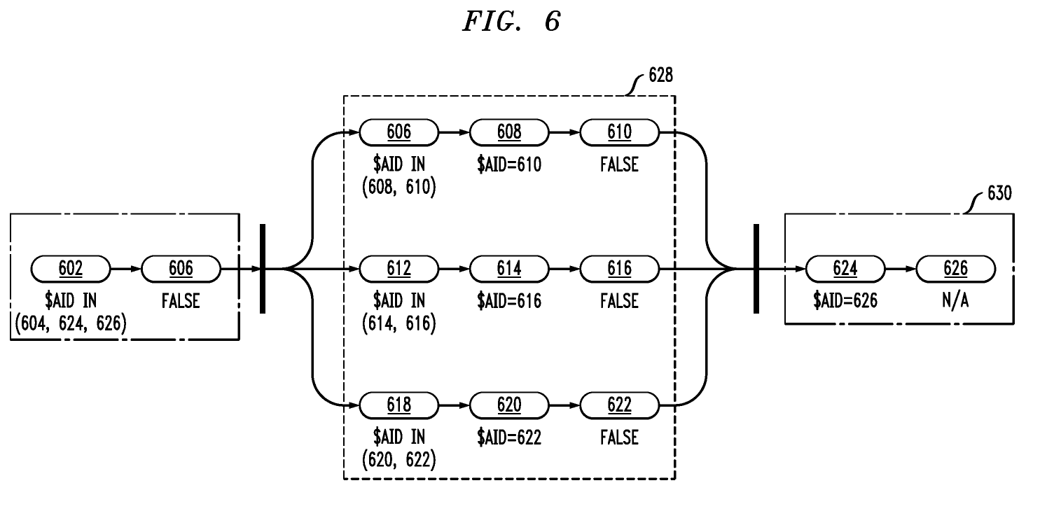

At present, it is believed that the preferred implementation will make substantial use of software running on a general-purpose computer or workstation. With reference to FIG. 5, such an implementation might employ, for example, a processor 502, a memory 504, and an input and/or output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 502, memory 504, and input and/or output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 518) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 504), magnetic tape, a removable computer diskette (for example, media 518), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor 502 coupled directly or indirectly to memory elements 504 through a system bus 510. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

FIG. 6 is a diagram illustrating selective backward routing, according to an embodiment of the present invention. By way of illustration, FIG. 6 depicts conditions to is allow backward routing in a workflow process that contains parallel split-join paths. FIG. 6 includes activities 602, 604, 606, 608, 610, 612, 614, 616, 618, 620, 622, 624 and 626, as well as scopes 628 and 630. In scope 628, backward routing to the multiple staff in the same branch path is allowed, while backward routing to the activities 602 and 604 is not allowed. In scope 630, backward routing to the parallel split-join area is not allowed. For activity 624, backward routing to the activity 602 is allowed. For activity 626, backward routing to the activity 602 or 624 is allowed.

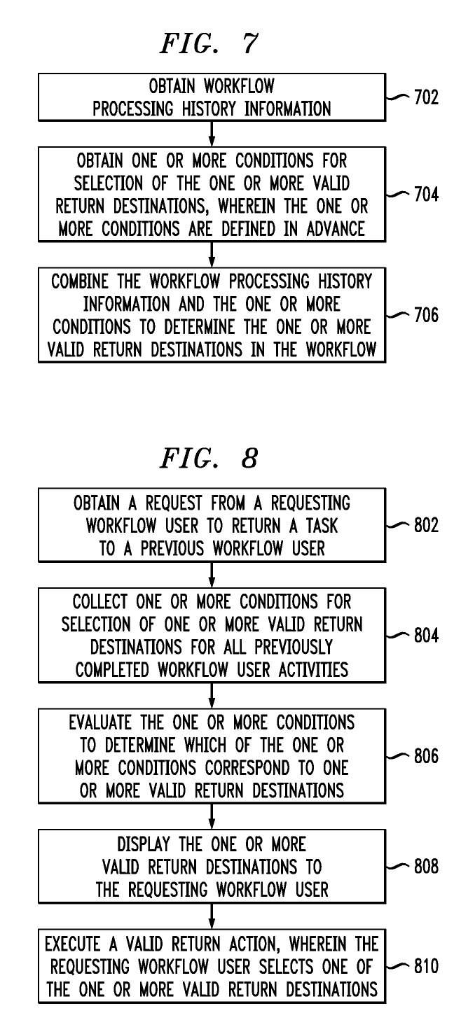

FIG. 7 is a flow diagram illustrating techniques for determining one or more valid return destinations in a workflow, according to an embodiment of the present invention. Step 702 includes obtaining workflow processing history information. Workflow processing history information can include, for example, information such as the date, the processor user name and the processing result (for example, March 1; Mike; Approved). Step 704 includes obtaining one or more conditions for selection of the one or more valid return destinations, wherein the one or more conditions are defined in advance. Obtaining one or more conditions may include, for example, determining which of one or more sets of workflow users can be a candidate for the one or more valid return destinations in accordance with the one or more conditions.

A condition may be defined in advance in accordance with workflow user activity. Also, a condition may include one or more design properties of a workflow user activity. Additionally, a condition may be described in a logical formula for evaluation by a workflow engine.

Step 706 includes combining the workflow processing history information and the one or more conditions to determine the one or more valid return destinations in the workflow. Combining the workflow processing history information and the one or more conditions may include, for example, generating a list of the one or more valid return destinations.

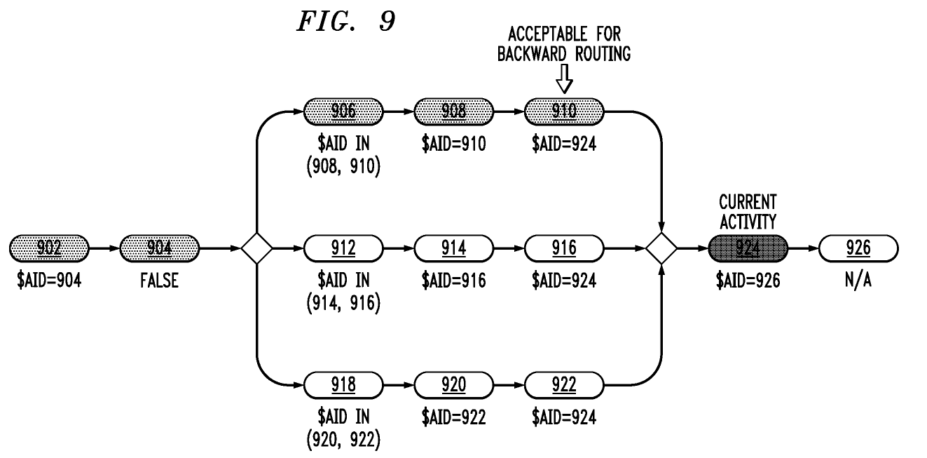

FIG. 8 is a flow diagram illustrating techniques for executing a valid return action in a workflow, according to an embodiment of the present invention. Step 802 includes obtaining a request from a requesting workflow user to return a task to a previous workflow user. A task may include a form. For example, in a human centric workflow, a workflow task can be equivalent to a handling form. An example of a form is a purchase request form. When a user would like to purchase something, he or she will fill in a purchase request form and submit it to the approver. The approver will then decide whether or not to approve the request form. Conditions to evaluate valid return destinations can be relevant to the data in the form.

Step 804 includes collecting one or more conditions for selection of one or more valid return destinations for all previously completed workflow user activities.

Step 806 includes evaluating the one or more conditions to determine which of the one or more conditions correspond to one or more valid return destinations. Evaluating the one or more conditions may include, for example, precluding at least one of the conditions from corresponding to a valid return destination when the at least one condition is set such that a workflow user activity is already approved. Additionally, evaluating the conditions may include precluding at least one of the conditions from corresponding to a valid return destination when the at least one condition is set such that a processing history contains an activity other than a workflow user activity.

One or more of the evaluated conditions may also be cached. Also, one or more of the conditions produced by a same workflow user activity may be differentiated.

Step 808 includes displaying the one or more valid return destinations to the requesting workflow user. Step 810 includes executing a valid return action, wherein the requesting workflow user selects one of the one or more valid return destinations.

A workflow user or a previous workflow user may include, for example, workflow staff, an approver, a customer service representative, etc. A requesting workflow user may include, for example, a client, a customer, workflow staff, an approver, a customer service representative, etc.

One or more embodiments of the present invention include caching evaluation results. By caching evaluation results for backward routing, performance of the same process at a second or later time would be improved. That cache information would be expired if the task or form is sent to the next activity by the workflow engine.

Additionally, one or more embodiments of the invention include using loop activity. When one activity is used repeatedly to assign separate staff, run-time conditions for backward routing can be utilized to differentiate each condition produced in the same activity. A set of application programming interfaces (APIs) would be provided to set the run-time conditions.

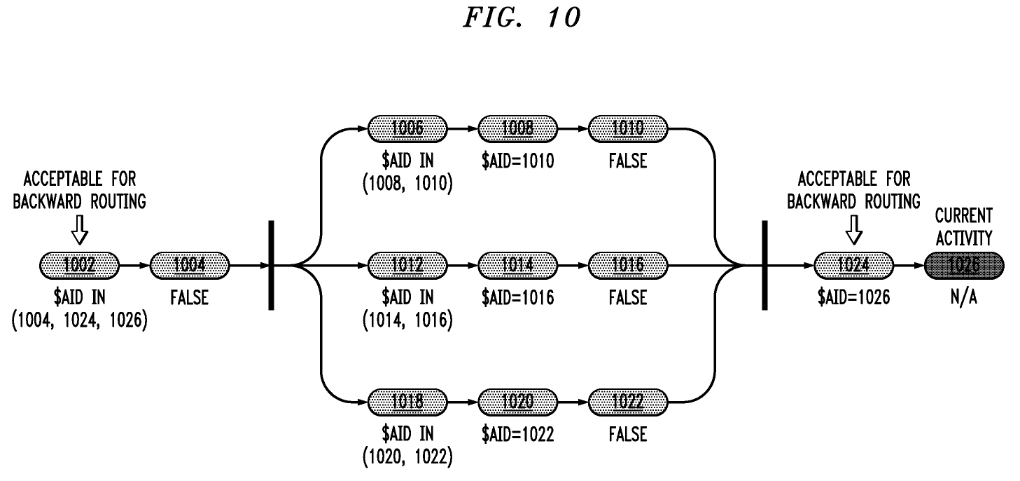

FIG. 9 is a diagram illustrating selective backward routing, according to an embodiment of the present invention. By way of illustration, FIG. 9 depicts an example of a graphical view of a current running workflow process instance where a candidate activity, illustrated herein as activity 910, for backward routing is identified. FIG. 9 includes activities 902, 904, 906, 908, 912, 914, 916, 918, 920, 922, 924 (which, as illustrated herein, is the current activity) and 926.

FIG. 10 is a diagram illustrating selective backward routing, according to an embodiment of the present invention. By way of illustration, FIG. 10 depicts an example of a graphical view of a running workflow process instance where candidate activities for backward routing are identified. FIG. 10 includes activities 1002, 1004, 1006, 1008, 1010, 1012, 1014, 1016, 1018, 1020, 1022, 1024 and 1026 (which, as illustrated herein, is the current activity).

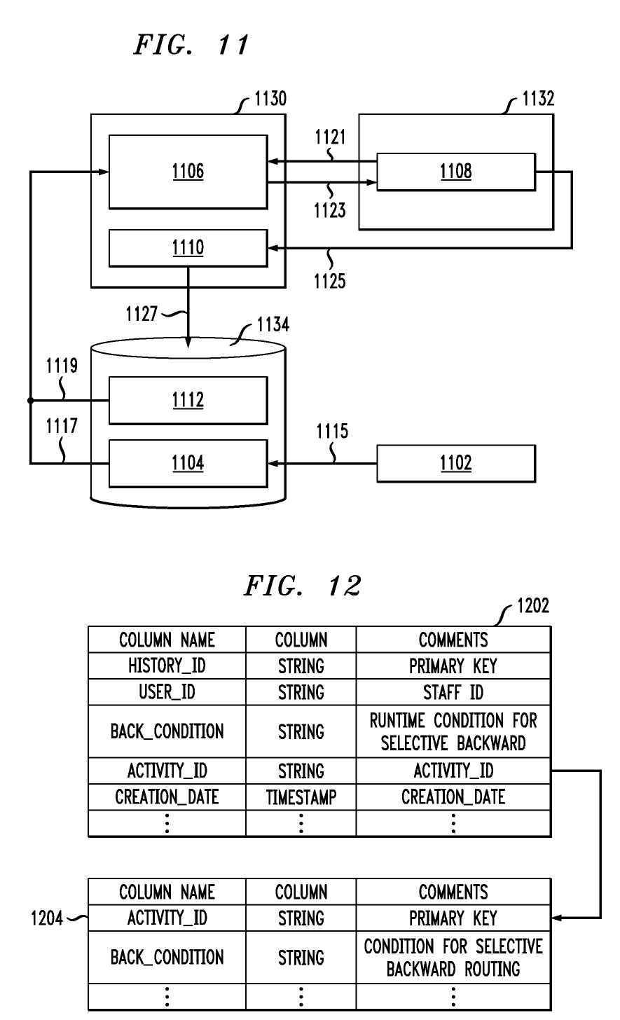

FIG. 11 is a diagram illustrating an exemplary system configuration, according to an embodiment of the present invention. By way of illustration, FIG. 11 includes a workflow process definition tool 1102, a process definition table 1104, an evaluation module for backward routing 1106, a user interface 1108 to select a destination for backward routing, an execution module for backward routing 1110, a processing history table 1112, a workflow engine 1130, a workflow client 1132 a workflow repository database 1134.

FIG. 11 also includes the following steps. In step 1115, conditions are assigned for selective backward routing. In step 1117, conditions for selective backward routing are retrieved from the workflow repository database 1134. In step 1119, history information is retrieved from the workflow repository database 1134. In step 1121, a user via the user interface 1108 generates a request for a destination list for backward routing. In step 1123, the evaluation module 1106 generates a list of destinations which contains effective candidates for backward routing. In step 1125, a user via the user interface 1108 selects a destination for backward routing. In step 1127, the workflow processing history information is updated.

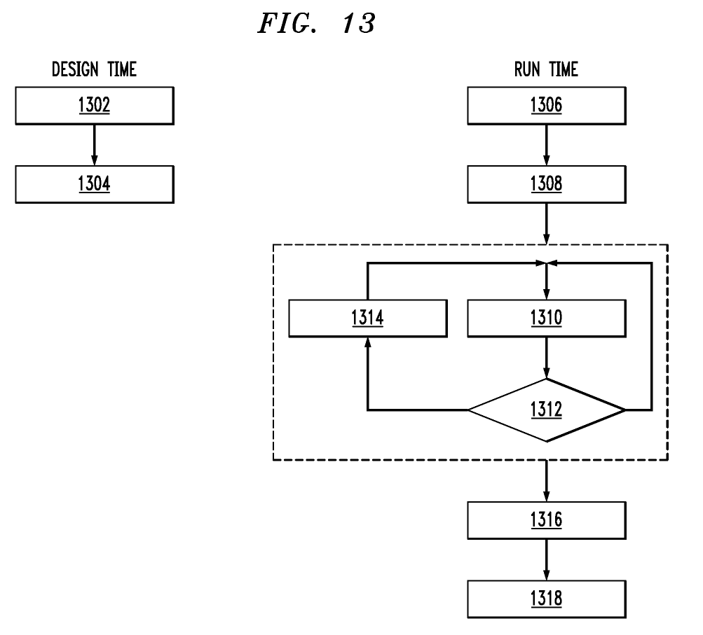

FIG. 12 is a diagram illustrating an exemplary data structure, according to an embodiment of the present invention. By way of illustration, FIG. 12 includes a workflow processing history information table 1202 and a workflow process definition table 1204.

FIG. 13 is a flow diagram illustrating techniques for selective backward routing, according to an embodiment of the present invention. By way of illustration, FIG. 13 includes the following steps. Steps 1302 and 1304 are performed during design time. In step 1302, conditions for selective backward routing are assigned to each activity by using a workflow process definition tool. In step 1304, sets of conditions for selective backward routing are saved to the workflow process definition table in the database.

Steps 1306, 1308, 1310, 1312, 1314, 1316 and 1318 are performed during run time. In step 1306, a workflow client (for example, a workflow user) requests a destination list for backward routing from the workflow engine through an application programming interface (API) for backward routing. In step 1308, the workflow engine retrieves processing history information from the database. For each item of history information, steps 1310, 1312 and 1314 are performed.

In step 1310, conditions for selective backward routing are retrieved by using activity identifications (IDs) as a key to search a database and evaluate the conditions. An ID may be used, for example, to ensure activity uniqueness in a workflow definition. If a run-time condition for selective backward routing is set, it is evaluated by priority. In step 1312, a determination is made as to whether the result of the evaluation is true. If yes (that is, if the evaluation is true), then the technique continues to step 1314, where the activity is added to the destination list. If no (that is, if the evaluation is false), then the technique reverts back to step 1310.

In step 1316, the workflow client (for example, the workflow user) is shown a list of effective destinations for backward routing via a user interface. The workflow user selects the destination to which he or she wants to return the current task or form, and sends the result or selection to the workflow engine. In step 1318, the workflow engine executes a backward routing (that is, a return) based on the destination which the workflow user has selected. The workflow engine sets the run-time conditions for selective backward routing for cancelled processing history entries in the workflow processing history information table to “false” so that those conditions cannot become candidates for backward routing in the future processing.

At least one embodiment of the invention may provide one or more beneficial effects, such as, for example, precluding the necessity to define backward paths, as well as including only valid staff in the backward destinations.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for determining one or more valid return destinations in a workflow, comprising the steps of:
obtaining workflow processing history information;
obtaining one or more conditions for selection of the one or more valid return destinations, wherein the one or more conditions are defined in advance; and
combining the workflow processing history information and the one or more conditions to determine the one or more valid return destinations in the workflow.

2. The method of claim 1, wherein the one or more conditions are defined in advance in accordance with workflow user activity.

3. The method of claim 1, wherein the step of combining the workflow processing history information and the one or more conditions comprises generating a list of the one or more valid return destinations.

4. The method of claim 1, wherein the step of obtaining one or more conditions comprises determining which of one or more sets of workflow users can be a candidate for the one or more valid return destinations in accordance with the one or more conditions.

5. The method of claim 1, wherein the one or more conditions comprise one or more design properties of a workflow user activity.

6. The method of claim 1, wherein the one or more conditions are described in a logical formula for evaluation by a workflow engine.

7. A method for executing a valid return action in a workflow, comprising the steps of:
obtaining a request from a requesting workflow user to return a task to a previous workflow user;
collecting one or more conditions for selection of one or more valid return destinations for all previously completed workflow user activities;
evaluating the one or more conditions to determine which of the one or more conditions correspond to one or more valid return destinations;
displaying the one or more valid return destinations to the requesting workflow user; and
executing a valid return action, wherein the requesting workflow user selects one of the one or more valid return destinations.

8. The method of claim 7, wherein the task comprises a form.

9. The method of claim 7, wherein the step of evaluating the one or more conditions comprises precluding at least one of the one or more conditions from corresponding to a valid return destination when the at least one of the one or more conditions is set such that a workflow user activity is already approved.

10. The method of claim 7, wherein the step of evaluating the one or more conditions comprises precluding at least one of the one or more conditions from corresponding to a valid return destination when the at least one of the one or more conditions is set such that a processing history contains an activity other than a workflow user activity.

11. The method of claim 7, further comprising the step of caching the one or more evaluated conditions.

12. The method of claim 7, further comprising the step of differentiating one or more conditions produced by a same workflow user activity.

13. A computer program product comprising a computer useable medium having computer useable program code for determining one or more valid return destinations in a workflow, said computer program product including:
computer useable program code for obtaining workflow processing history information;
computer useable program code for obtaining one or more conditions for selection of the one or more valid return destinations, wherein the one or more conditions are defined in advance; and
computer useable program code for combining the workflow processing history information and the one or more conditions to determine the one or more valid return destinations in the workflow.

14. The computer program product of claim 13, wherein the one or more conditions are defined in advance in accordance with workflow user activity.

15. The computer program product of claim 13, wherein the computer useable program code for obtaining one or more conditions comprises determining which of one or more sets of workflow users can be a candidate for the one or more valid return destinations in accordance with the one or more conditions.

16. The computer program product of claim 13, wherein the one or more conditions are described in a logical formula for evaluation by a workflow engine.

17. A computer program product comprising a computer useable medium having computer useable program code for executing a valid return action in a workflow, said computer program product including:
computer useable program code for obtaining a request from a requesting workflow user to return a task to a previous workflow user;
computer useable program code for collecting one or more conditions for selection of one or more valid return destinations for all previously completed workflow user activities;
computer useable program code for evaluating the one or more conditions to determine which of the one or more conditions correspond to one or more valid return destinations;
computer useable program code for displaying the one or more valid return destinations to the requesting workflow user; and
computer useable program code for executing a valid return action, wherein the requesting workflow user selects one of the one or more valid return destinations.

18. The computer program product of claim 17, wherein the computer useable program code for evaluating the one or more conditions comprises at least one of:
computer useable code for precluding at least one of the one or more conditions from corresponding to a valid return destination when the at least one of the one or more conditions is set such that a workflow user activity is already approved; and
computer useable code for precluding at least one of the one or more conditions from corresponding to a valid return destination when the at least one of the one or more conditions is set such that a processing history contains an activity other than a workflow user activity.

19. The computer program product of claim 17, further comprising additional computer useable program code for caching the one or more evaluated conditions.

20. The computer program product of claim 17, further comprising additional computer useable program code for differentiating one or more conditions produced by a same workflow user activity.
